(19) United States
(12) Patent Application Publication
(10) Pub. No.: US 2016/0183710 A1
(43) Pub. Date: Jun. 30, 2016

(54) Rice Cooking Insert

(71) Applicant: Tristar Products, Inc., Fairfield, NJ (US)

(72) Inventor: Kevin Wheatley, Las Palmas (ES)

(21) Appl. No.: 14/930,662

(22) Filed: Nov. 3, 2015

Related U.S. Application Data
(60) Provisional application No. 62/074,621, filed on Nov. 3, 2014.

(51) Int. Cl. A47J 27/026

(52) U.S. Cl. CPC A47J 27/026

(57) ABSTRACT

A rice cooking insert includes a ring shaped body with a curved bottom includes at least one stand that interacts with the bottom surface of the body and is configured to suspend the body above a heating element

### TECHNICAL FIELD

The present invention relates to the field of cooking apparatuses, and more particularly, to a rice cooking insert that can be positioned within pot or affixed to a pot.

### BACKGROUND OF THE INVENTION

Various rice cookers are known in the art. In many of these, the bottom of the container makes direct contact with a heating element. As a result, as water is absorbed and/or evaporated, the rice near the bottom may become crispy or burnt while the rice above is cooked.

Thus, there is a clear need for a rice cooking insert that protects all portions of the rice.

### SUMMARY OF EMBODIMENTS OF THE INVENTION

A rice cooking insert includes a ring shaped body having a curved bottom. A first side wall of the body forms an interior cavity with an opening at the top. A second side wall of the body forms an interior reverse funnel shaped structure that defines a center bore. In addition, the curved bottom of the body includes slots. Handles are secured to the exterior of the sides of the body. The ringed shaped body includes a lip below the handle to catch the edge of a pot. Furthermore, at least one stand interacts with the bottom surface of the body and is configured to suspend the body from a heating element. The rice cooking insert includes a lid with a vent.

Other objects, features, and characteristics of the present invention, as well as methods of operation and functions of the related elements of the structure and the combination of parts, will become more apparent upon consideration of the following detailed description with reference to the accompanying drawings, all of which form part of this specification.

### BRIEF DESCRIPTION OF THE DRAWINGS

A further understanding of the invention can be obtained by reference to a preferred embodiment set forth in the illustrations of the accompanying drawings. Although the illustrated embodiment is merely exemplary of systems and methods for carrying out the invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

The detailed description makes reference to the accompanying figures wherein:

FIG. 1 illustrates a top perspective view of the rice cooking insert with the cover affixed in accordance with the preferred embodiment of the present invention.

FIG. 2 illustrates a bottom perspective view of rice cooking insert shown in FIG. 1.

FIG. 3 illustrates a front view of the rice cooking insert shown in FIG. 1.

FIG. 4 illustrates a bottom view of the rice cooking insert shown in FIG. 1.

FIG. 5 illustrates a top view of the rice cooking insert shown in FIG. 1.

FIG. 6 illustrates a cross-sectional front view of the rice cooking insert shown in FIG. 1.

FIG. 7 illustrates a top view of the rice cooking insert shown in FIG. 1 with the cover removed.

FIG. 8 illustrates a top perspective view of the rice cooking insert shown in FIG. 7.

FIG. 9 illustrates a top perspective view of the ricer cooking insert shown in FIG. 1 with cover nested within a pot.

FIG. 10 illustrates a cross-sectional front view of the rice cooking insert shown in FIG. 9.

FIG. 11 is a top perspective view of the rice cooking insert with cover removed nested within a pot.

FIG. 12 is a cross-sectional front view of the rice cooking illustrated in FIG. 11.

### DETAILED DESCRIPTION OF THE PREFERRED EMBODIMENT

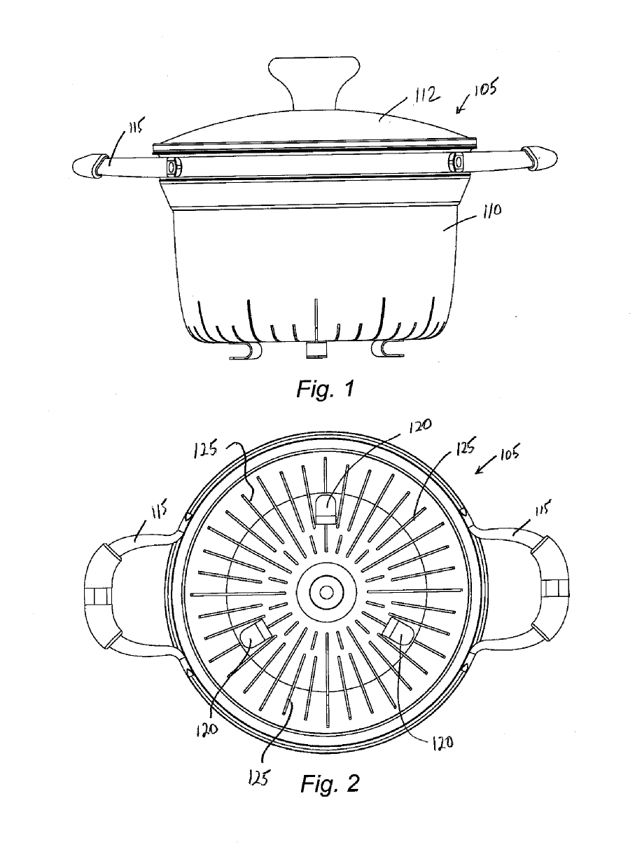

FIG. 1, shows a perspective view of the rice cooking insert according to a preferred embodiment of the present invention. The rice cooking insert 105 includes a body 110 and a lid 112. At least one handle 115 is secured to the exterior of the body 110. The handle 115 is preferably composed of a heat resistant material, for example silicon, which allows the user to transport the rice cooking insert after it has been heated.

In FIG. 2, the bottom perspective of the rice cooking insert depicts at least one stand 120 secured to the bottom surface of the body 110 of the rice cooking insert. In the preferred embodiment, three stands 120 are secured to the bottom surface of the cooking insert. Further, the bottom of the body 110 includes at least one slit, slot 125, or opening. The slots 125 are preferably configured to allow fluid, for example water, to enter into the body 110 of the cooking insert and prevent the grains positioned within the body 110 from passing through. In the preferred embodiment, the grains inserted into the body 110 is rice. It would be obvious to one of ordinary skill in the art to configure the slots 125 to allow the rice cooking utilize quinoa or couscous without departing from the spirit of the invention disclosed.

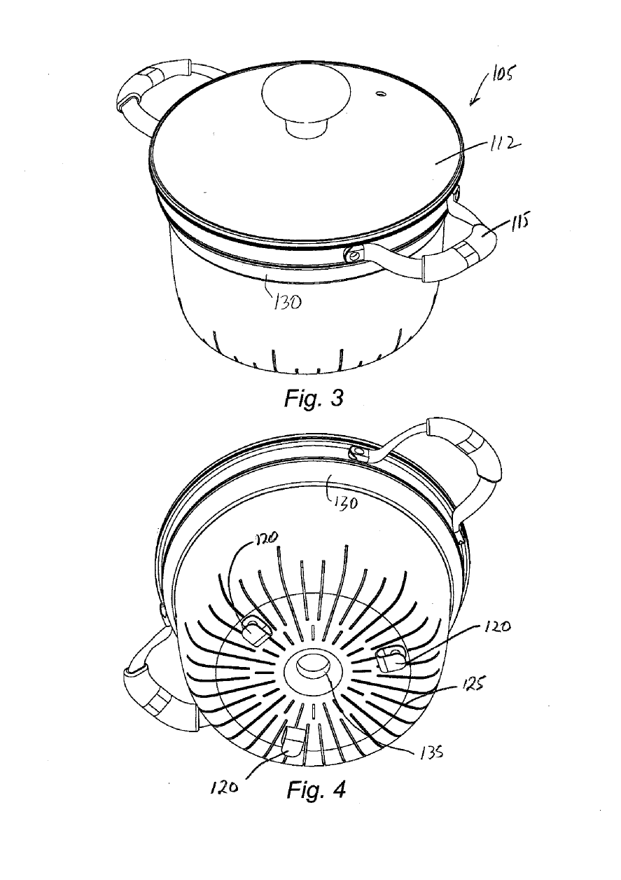

As shown in FIG. 3, the body 110 of the cooking insert includes a lip 130 around a portion below the at least one handle 115 secured to the exterior of the body 110. Further, the radius of the body 110 below the lip 130 portion is less than the radius of the body 110 above the lip 130 portion. In the preferred embodiment, the stands 120 are C-shaped structures and configured to suspend the bottom of the rice cooking insert from the object that the stand 120 contacts.

FIG. 4 depicts the bottom of the rice cooking insert wherein the stands 120 are configured in a triangular orientation. It would be obvious to one of ordinary skill in the art to utilize other configurations, for example a rectangular orientation, to support the body 110 of the rice cooking insert. Also shown in FIG. 4 is at least one bore 135 that extends substantially through the center of the body 110.

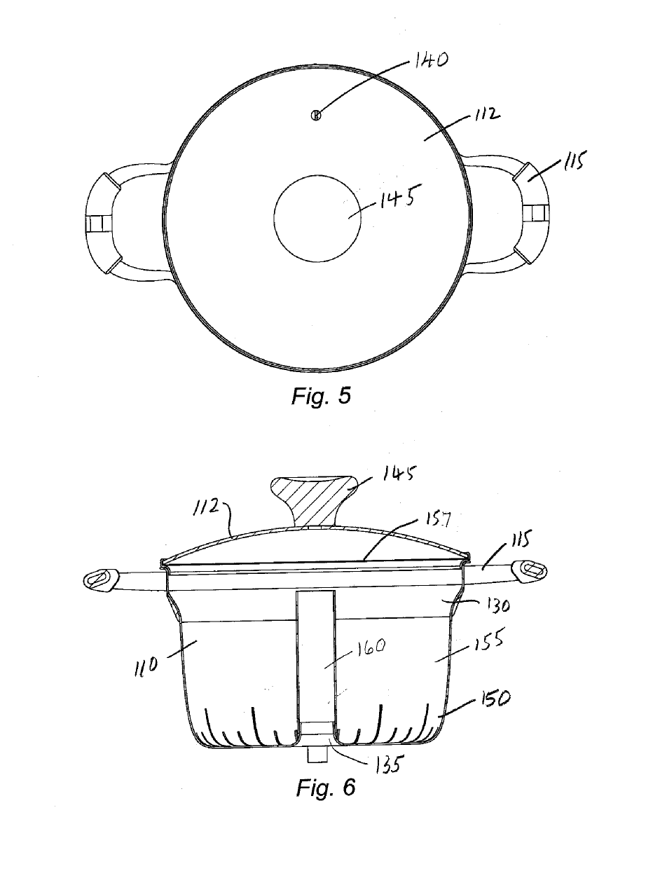

As shown in FIG. 5 the top of the lid 112 includes a vent 140 and lid handle 145. The lid handle 145 is preferable composed of a heat resistant material, for example silicon. It would be obvious to one of ordinary skill in the art to utilize other handles for the lid, or hinge the lid to the body 110 with a mechanism to open the hinged lid, for example, by depressing the handles on the rice cooking insert with a sufficient force.

FIG. 6 is a cross-sectional side view of the rice cooking insert according to the preferred embodiment of the present invention. The rice cooking insert includes a ring shaped body 110 having a curved bottom. A first side wall of the body 110 forms an interior cavity 155 with an opening 157 at the top. The lid 112 is placed on the opening at the top. A second side wall of the body 110 forms an interior reverse funnel shaped structure that defines a center bore 135 and cylinder 160. It would obvious to one of ordinary skill in the art to utilize other structures such as a column to define the center bore 135, without departing from the spirit of the present invention. In the preferred embodiment the funnel shaped structure extends to level below the position of the handles secured to the exterior of the body 110. Further, the lid 112 is preferably concave.

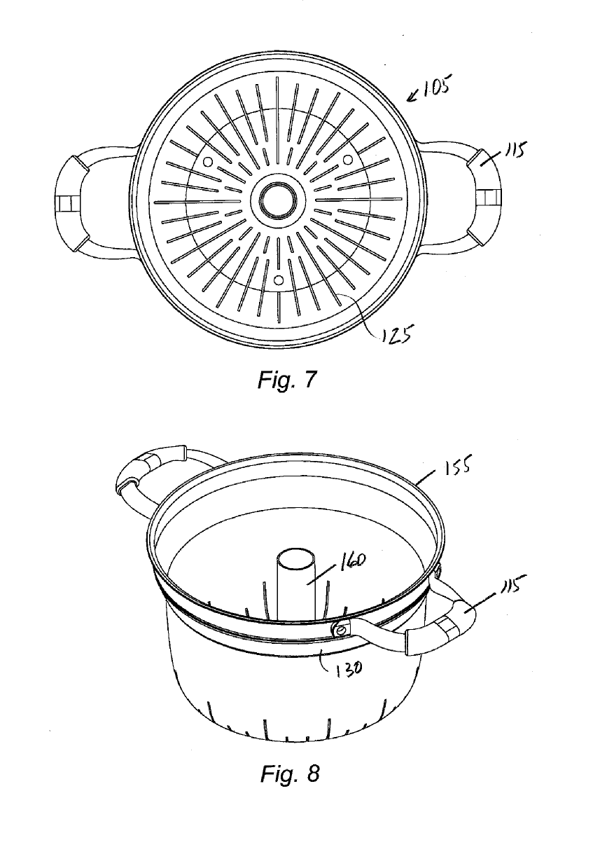

FIG. 7 depicts a top view of the rice cooking insert with the lid 112 removed. As shown, the stands 120 are secured on the inside and outside surface of the bottom of the body 110. The inside surface of the body 110 is preferably coated with nonstick material, for example, polytetrafluoroethylene, anodized aluminum, ceramics, silicone, enameled cast iron, and seasoned cast iron.

In FIG. 8 the structure that defines the center bore 135 of the body 110 does extends to a level below the lip 130 portion of the body 110.

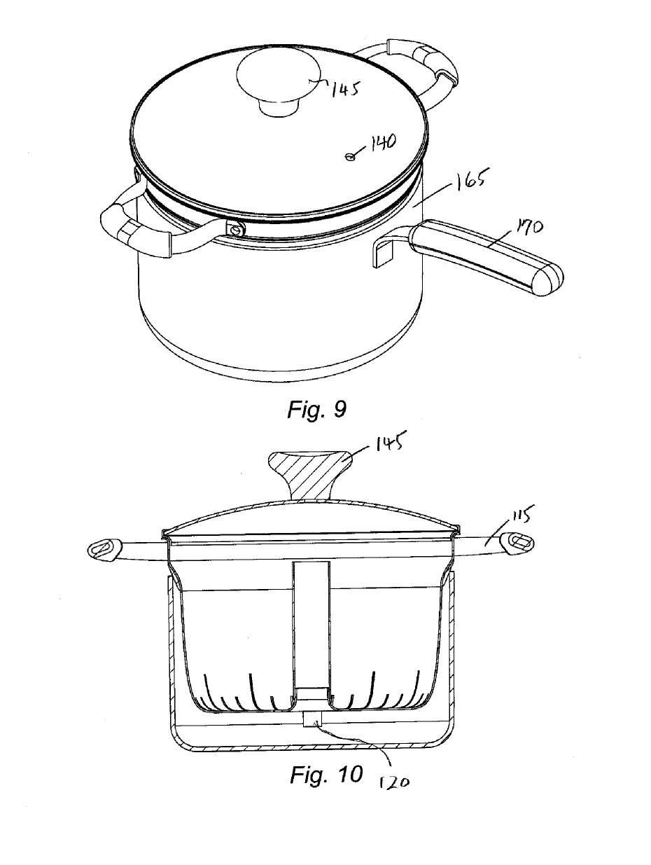

As shown in FIG. 9, the rice cooking insert is affixed to a pot or nested within the pot. The pot is a conventional pot and includes a handle.

FIG. 10 illustrates a cross-sectional side view of the rice cooking insert affixed to a pot. The lip portion of the rice cooking insert is caught along the top edge of the pot. The lip portion that contacts the edge of the pot is preferably composed of an insulator, for example ceramic. Also shown in FIG. 10, the stands 120 suspend the bottom of the rice cooking insert from the bottom of the pot. The stands 120 are preferably composed of an insulator, for example, ceramic. In addition, the sides of the rice cooker inserts are positioned away from the sides of the pot, due to the smaller radius of the body 110 below the lip 130 portion.

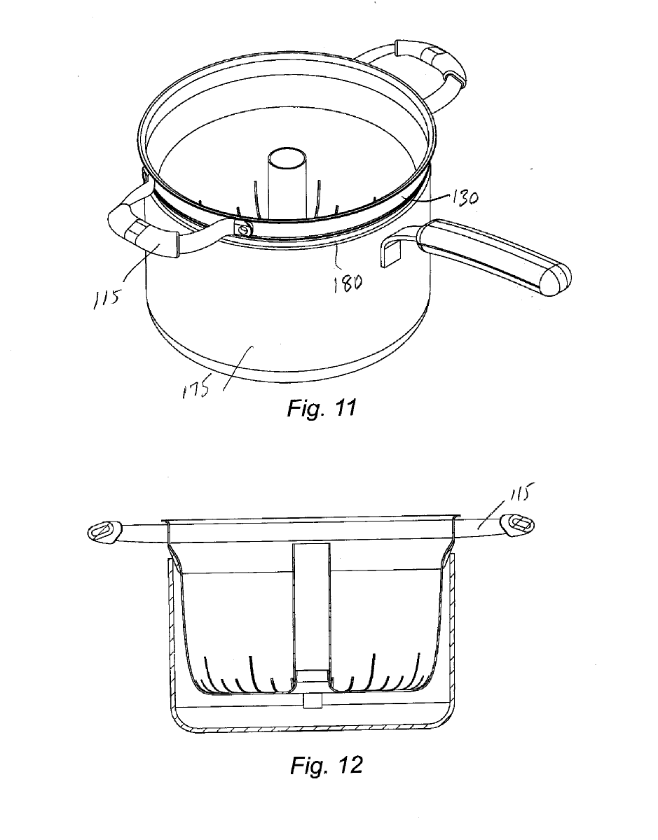

In FIG. 11, the rice cooking insert is affixed to a pot 175 with the lid 112 removed. As shown, the rice cooking insert is coupled along the outer top edge 180 of the pot.

In FIG. 12, the cross-sectional front view shows that the rice cooking insert stacked within the pot.

The process of cooking a grain using the rice cooking insert depicted in the present invention begins with the user selecting a pot into which to place the rice cooking insert. The pot needs to be deep enough to allow the lip portion of the rice cooking insert to abut around the top edge of the pot. Thereafter, the user can insert the grains that the user wishes to cook in the rice cooking insert. Due to the slots 125 at the bottom of the rice cooking insert, the user can clean the grains of starch and other particulates by running water over the grains in a sink. Next, the user places the rice cooking insert with clean or non-cleaned grains into the pot that the user selected in the previous step. Then, the user inserts fluid, for example water or a broth, into the pot where the rice cooker insert is attached, based on the user's desired amount of rice. As the fluid fills the rice cooking insert and pot combination, it will enter the rice cooking insert through the slots 125. In addition, some fluid will enter the structure forming a center core. Then, the user can place the lid 112 on the rice cooking insert and place the rice cooking insert and pot combination on a heating element. Due to the stands 120 on the rice cooking insert, the bottom of the rice cooking insert is not in direct contact with the heating element. In addition, as the heating element heats the fluid, steam and some of the fluid will travel through the structure forming the center bore 135. The fluid and/or steam are discharged on the grains located at the top of the rice cooking insert. Further, the sides of the rice cooking insert are not heated by the side of the pot, which may be heated by the heating element. As a result, the grains throughout the bottom and top of the rice cooking insert are heated and in turn cooked by the water. Therefore, the risk of the grains located at the bottom of the rice cooking insert becoming crispy or burnt are reduced.

A detailed illustrative embodiment of the present invention is disclosed herein. However, techniques, methods, processes, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

None of the terms used herein, including “housing,” “body,” “portion,” and “section” are meant to limit the application of the invention. The terms are used to illustrate the preferred embodiment and are not intended to limit the scope of the invention. Similarly, the use of these terms is not meant to limit the scope or application of the invention, as the invention is versatile and can be utilized in many applications, as will be apparent in light of the disclosure set forth herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, electronic or otherwise, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the Detailed Description of the Embodiments using the singular or plural number may also include the plural or singular number respectively. The word “or,” in reference to a list of two or more items, covers all of the following interpretations of the word: any of the items in the list, all of the items in the list, and any combination of the items in the list. The following presents a detailed description of the preferred embodiment of the present invention with reference to the figures.

While the present invention has been described with reference to the preferred embodiment, which has been set forth in considerable detail for the purposes of making a complete disclosure of the invention, the preferred embodiment is merely exemplary and is not intended to be limiting or represent an exhaustive enumeration of all aspects of the invention. The scope of the invention, therefore, shall be defined solely by the claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A cooking apparatus comprising:
ring shaped body having a curved bottom,
slots through the curved bottom,
a stand on the underside of the curved bottom.

2. An apparatus as in claim 1, wherein said ring shaped body has a lip to catch an edge of a container.

3. An apparatus as in claim 1, wherein said curved bottom has an opening forming a column ascending upwardly in the center of said body.
